(19) United States
(12) Patent Application Publication
(10) Pub. No.: US 2026/0297775 A1
(43) Pub. Date: Oct. 1, 2026

(54) METAL NITRIDE HYBRID COMPOSITE CATALYST, MANUFACTURING METHOD THEREOF, AND WATER ELECTROLYSIS APPARATUS HAVING THE SAME

(71) Applicant: UIF(UNIVERSITY INDUSTRY FOUNDATION), YONSEI UNIVERSITY, Seoul (KR)

(72) Inventors: Seong Ju HWANG, Seoul (KR); YIYANG SUN, Seoul (KR); XiaoYan JIN, Seoul (KR)

(73) Assignee: UIF(UNIVERSITY INDUSTRY FOUNDATION), YONSEI UNIVERSITY, Seoul (KR)

(21) Appl. No.: 19/632,411

(22) Filed: Mar. 30, 2026

(30) Foreign Application Priority Data
Apr. 1, 2025 (KR) 10-2025-0042088

(51) Int. Cl. C25B 11/091; C25B 9/23; C25B 11/052; H01M 4/86; H01M 4/90; H01M 12/08

(52) U.S. Cl. CPC C25B 11/091; C25B 9/23; C25B 11/052; H01M 4/8647; H01M 4/9016; H01M 12/08

(57) ABSTRACT

A metal nitride hybrid composite catalyst having catalytic activity for an oxygen evolution reaction (OER), a hydrogen evolution reaction (HER), or an oxygen reduction reaction (ORR) is disclosed. The metal nitride hybrid composite catalyst may include a cerium-substituted metal nitride particle and a layered metal double hydroxide nanosheet grown on a surface of the metal nitride particle.

### CROSS-REFERENCE TO RELATED APPLICATION

This application claims the benefit of Korean Patent Application No. 10-2025-0042088 filed on Apr. 1, 2025, in the Korean Intellectual Property Office, the entire disclosure of which is incorporated herein by reference for all purposes.

### BACKGROUND

### 1. Field of the Invention

The present disclosure relates to a metal nitride hybrid composite catalyst having catalytic activity for an oxygen evolution reaction, a manufacturing method thereof, and a water electrolysis apparatus having the same.

### 2. Description of the Related Art

Due to issues such as the depletion of fossil fuels and environmental pollution, research has been actively conducted on environmentally friendly renewable energy devices that use hydrogen, such as fuel cells, and metal-air secondary batteries that store energy generated from renewable energy devices.

To produce the hydrogen in an environmentally friendly manner, water electrolysis apparatuses are widely used, and these water electrolysis apparatuses may produce hydrogen and oxygen from water through an oxygen evolution reaction (OER) that occurs at a positive electrode and a hydrogen evolution reaction (HER) that occurs at a negative electrode.

In the case of water electrolysis apparatuses that are currently commercialized or mainly being studied, precious metal-based materials such as iridium and ruthenium have been mainly used as catalysts for the oxygen evolution reaction (OER) or the hydrogen evolution reaction (HER); however, in order to address decreased economic feasibility due to the high price of the catalyst as well as to further improve stability, various studies are being conducted on non-precious metal-based catalyst materials.

Of the non-precious metal-based catalysts, layered metal double hydroxide (LDH) catalysts are inexpensive and abundant compared to precious metals, thereby attracting much attention as catalysts for OER or HER. However, the layered metal double hydroxide (LDH) catalyst bears a problem in that it is difficult to expect high catalytic activities due to low electrical conductivity.

### SUMMARY

### Problem to be Solved by the Invention

An object of the present disclosure is to provide a metal nitride hybrid composite catalyst having a relatively high electrical conductivity and a high catalytic activity for the OER or HER reaction.

Another object of the present disclosure is to provide a method of manufacturing the metal nitride hybrid composite catalyst.

Another object of the present disclosure is to provide a water electrolysis apparatus that uses the metal nitride hybrid composite catalyst as a catalyst for the OER or HER reaction.

### Means for Solving the Problem

A metal nitride hybrid composite catalyst according to an embodiment of the present disclosure may include a cerium-substituted metal nitride particle and a layered metal double hydroxide nanosheet grown on a surface of the metal nitride particle.

In an embodiment, the layered metal double hydroxide nanosheet may be arranged to form open pores on the surface of the metal nitride particle.

In an embodiment, the metal nitride particle may include a material represented by the following Chemical Formula 1.

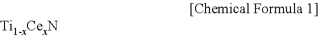

In the Chemical Formula 1, x is a real number greater than or equal to 0.025 and less than or equal to 0.075.

In an embodiment, the metal nitride particle may be crystalline with a rock salt structure.

In an embodiment, the layered metal double hydroxide nanosheet may include a material represented by the following Chemical Formula 2.

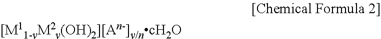

In the Chemical Formula 2, M¹ is a first transition metal cation having an oxidation state of +2, M² is a second transition metal cation having an oxidation state of +3, A is an interlayer anion having an oxidation state of −n, y is a real number satisfying the condition of “0<y<1”, n is an integer greater than or equal to 1 and less than or equal to 5, and c is a positive real number.

In an embodiment, the first transition metal cation includes any one or more selected from the group consisting of Ca²⁺, Mg²⁺, Zn²⁺, Ni²⁺, Mn²⁺, Co²⁺, Fe²⁺, and Cu²⁺, the second transition metal cation includes one or more selected from the group consisting of Fe³⁺, Al³⁺, Cr³⁺, Mn³⁺, Ga³⁺, Co³⁺, V³⁺, Y³⁺, and Ni³⁺, and the interlayer anion includes one or more selected from the group consisting of OH⁻, Cl⁻, Br⁻, I⁻, NO₃⁻, CO₃²⁻, HCO₃⁻, SO₄²⁻, PO₄³⁻, HPO₄²⁻ and H₂PO₄⁻.

A method of manufacturing a metal nitride hybrid composite catalyst according to an embodiment of the present disclosure may include a first step of forming cerium-substituted metal oxide particles using a hydrothermal synthesis method, a second step of converting the metal oxide particles into metal nitride particles, and a third step of forming layered metal double hydroxide nanosheets on a surface of the metal nitride particles using a hydrothermal synthesis method.

In an embodiment, the second step may be performed by heat treating the metal oxide particles in a nitrogen-containing atmosphere.

In an embodiment, the second step may be performed by heat treating the metal oxide particles at a temperature of 600 to 1000° C. for 0.5 to 10 hours under an ammonia gas atmosphere.

In an embodiment, the third step is performed, while the metal nitride particles are dispersed in a mixed precursor solution for a layered metal double hydroxide, by heating the mixed precursor solution in an inert atmosphere to 120 to 200° C. for 20 to 48 hours, and, during the third step, the layered metal double hydroxide nanosheets may be grown on the surface of the metal nitride particles.

In an embodiment, the metal nitride particles may be formed to have a size of 5 to 50 nm.

A water electrolysis apparatus according to an embodiment of the present disclosure may include an ion exchange membrane and a first electrode and a second electrode facing each other with the ion exchange membrane interposed therebetween, wherein the first electrode, in which an oxygen evolution reaction (OER) occurs, may include a metal nitride hybrid composite catalyst including a cerium-substituted metal nitride particle and a layered metal double hydroxide nanosheet formed on a surface of the metal nitride particle.

In an embodiment, the first electrode may include a first catalyst layer disposed adjacent to the ion exchange membrane and a first gas diffusion layer disposed on an outer side of the first catalyst layer, wherein the first catalyst layer may include the layered metal double hydroxide catalyst.

A metal-air secondary battery according to an embodiment of the present disclosure may include an air electrode and a metal electrode that are spaced apart from each other and an electrolyte disposed between the air electrode and the metal electrode, wherein the air electrode may include a metal nitride hybrid composite catalyst having a cerium-substituted metal nitride particle and a layered metal double hydroxide nanosheet formed on a surface of the metal nitride particle.

In an embodiment, the metal electrode may include any one metal selected from the group consisting of zinc (Zn), lithium (Li), and aluminum (Al).

### Effects of the Invention

According to a metal nitride hybrid composite catalyst of the present disclosure, a manufacturing method thereof, and a water electrolysis apparatus including the same, layered metal double hydroxide nanosheets are formed on the surface of cerium-substituted metal nitride particles, thereby significantly improving catalytic activities for an OER reaction and HER reaction while ensuring economically feasibility by containing non-precious metals.

### BRIEF DESCRIPTION OF THE DRAWINGS

FIG. 1 shows a flowchart to illustrate a method of manufacturing a metal nitride hybrid composite catalyst according to an embodiment of the present disclosure.

FIG. 2 shows a diagram to illustrate a water electrolysis apparatus according to an embodiment of the present disclosure.

FIG. 3 shows a diagram to illustrate a metal-air secondary battery according to an embodiment of the present disclosure.

FIG. 4 shows X-ray powder diffraction analysis data of Ti₁₋ₓCeₓO₂ (a) and Ti₁₋ₓCeₓN (b) materials.

FIG. 5 shows X-ray powder diffraction analysis data for Ti₁₋ₓCeₓN-LDH.

FIG. 6 shows field emission scanning electron microscopic (FE-SEM) images for Ti₁₋ₓCeₓN-LDH.

FIG. 7 shows transmission electron microscope-elemental analysis images for Ti₁₋ₓCeₓN-LDH.

FIG. 8 shows a graph of measuring an activity of oxygen evolution reaction of catalysts prepared in the Examples and Comparative Examples.

### DETAILED DESCRIPTION

Hereinafter, embodiments of the present disclosure will be described in detail with reference to the accompanying drawings. The present disclosure may be modified in various ways and may take various forms, and specific embodiments are illustrated in the drawings and described in detail in the specification. However, this is not intended to limit the present disclosure to a specific disclosure form, and it should be understood that it includes all modifications, equivalents, or substitutes included in the spirit and technical scope of the present disclosure. In describing each drawing, like reference numerals are used for similar components. In the accompanying drawings, the dimensions of the structures are enlarged from the actual size to ensure clarity of the present disclosure.

The terms first, second, and the like may be used to describe various components, but the components should not be limited by the terms. The terms are used solely to distinguish one component from another. For example, without departing from the scope of the present disclosure, a first component may be referred to as a second component, and similarly, the second component may also be referred to as the first component.

The terms used in this application are for the purpose of describing specific embodiments only and are not intended to limit the present disclosure. Singular expressions include plural expressions unless the context clearly indicates otherwise. It should be understood that terms such as “comprise”, “include” or “have” as used herein are intended to specify the presence of a feature, step, operation, component, part, or combination thereof stated in the specification, but not to exclude in advance the possibility of the presence or addition of one or more other features, steps, operations, components, parts, or combinations thereof.

Unless otherwise defined, all terms used herein, including technical or scientific terms, have the same meaning as commonly understood by one of ordinary skill in the art to which the present disclosure pertains. Terms that are defined in commonly used dictionaries should be interpreted to have a meaning consistent with their meaning in the context of the relevant art, and will not be interpreted in an idealized or overly formal sense unless expressly defined in this application.

### <Metal Nitride Hybrid Composite Catalyst>

A metal nitride hybrid composite catalyst according to an embodiment of the present disclosure may include a cerium-substituted metal nitride particle and a layered metal double hydroxide nanosheet grown on a surface of the metal nitride particle, and may exhibit catalytic activity that promotes an oxygen evolution reaction (OER), a hydrogen evolution reaction (HER), or an oxygen reduction reaction (ORR).

In an embodiment, the metal nitride particle may include a material represented by the following Chemical Formula 1 and may have a spherical particle shape.

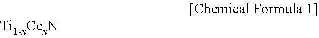

In the Chemical Formula 1, x is a real number greater than or equal to 0.025 and less than or equal to 0.075.

In an embodiment, in the Chemical Formula 1, x may be a real number greater than or equal to 0.025 and less than or equal to 0.050, or a real number greater than or equal to 0.050 and less than or equal to 0.075.

In an embodiment, the metal nitride particle may be crystalline with a rock salt structure.

In an embodiment, the layered metal double hydroxide nanosheet is arranged to form open pores on the surface of the metal nitride particles, thereby more actively promoting the oxygen evolution reaction

The layered metal double hydroxide nanosheet may be grown upward from the surface of the metal nitride particle through a hydrothermal synthesis method. For example, the layered metal double hydroxide nanosheet may be grown upward in a direction perpendicular or inclined to the surface of the metal nitride particles.

In an embodiment, the layered metal double hydroxide nanosheet may include a material represented by the following Chemical Formula 2 and may have a layered metal bilayer structure.

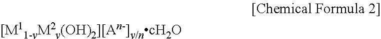

In the Chemical Formula 2, M¹ is a first transition metal cation having an oxidation state of +2, M² is a second transition metal cation having an oxidation state of +3, A is an interlayer anion having an oxidation state of −n, y is a real number satisfying the condition of “0<y<1”, n is an integer greater than or equal to 1 and less than or equal to 5, and c is a positive real number.

In an embodiment, the first transition metal cation may include any one or more selected from the group consisting of Ca²⁺, Mg²⁺, Zn²⁺, Ni²⁺, Mn²⁺, Co²⁺, Fe²⁺, and Cu²⁺, the second transition metal cation may include one or more selected from the group consisting of Fe³⁺, Al³⁺, Cr³⁺, Mn³⁺, Ga³⁺, Co³⁺, V³⁺, Y³⁺, and Ni³⁺, and the interlayer anion may include one or more selected from the group consisting of OH⁻, Cl⁻, Br⁻, I⁻, NO₃⁻, CO₃²⁻, HCO₃⁻, SO₄²⁻, PO₄³⁻, HPO₄²⁻, and H₂PO₄⁻.

In an embodiment, the layered metal double hydroxide (LDH) nanosheet of the Chemical Formula 1 may have a structure in which the interlayer anions are arranged between two-dimensional layered structures formed by covalently bonding a first octahedral structure formed by each of the first transition metal cations being coordinated by six hydroxide ions (OH⁻) and a second octahedral structure formed by each of the second transition metal cations being coordinated by six hydroxide ions (OH⁻). In an embodiment, in the Chemical Formula 2, x may be about 0.2 or greater and 0.5 or less, for example, about 0.3 to 0.4.

In an embodiment, the layered metal double hydroxide nanosheet of the Chemical Formula 2 may include Ni—Fe LDH or Co—Fe LDH.

In an embodiment, the layered metal double hydroxide nanosheet may have a nanosheet form having a size of about 20 to 1000 nm.

The metal nitride hybrid composite catalyst of the present disclosure has a structure in which the metal double hydroxide nanosheets are grown on the surface of the metal nitride particles having relatively high conductivity, and therefore may exhibit significantly improved catalytic performance for the oxygen evolution reaction (OER), hydrogen evolution reaction (HER), or oxygen reduction reaction (ORR) compared to the metal double hydroxide nanosheets alone.

### <Method of Manufacturing a Metal Nitride Hybrid Composite Catalyst>

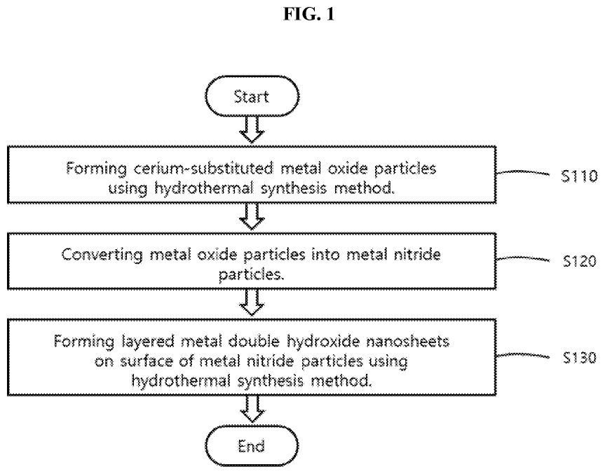

FIG. 1 shows a flowchart to illustrate a method of manufacturing a metal nitride hybrid composite catalyst according to an embodiment of the present disclosure.

Referring to FIG. 1, a method of manufacturing a metal nitride hybrid composite catalyst according to an embodiment of the present disclosure may include a first step S110 of forming cerium-substituted metal oxide particles using a hydrothermal synthesis method, a second step S120 of converting the metal oxide particles into metal nitride particles, and a third step S130 of forming layered metal double hydroxide nanosheets on a surface of the metal nitride particles using the hydrothermal synthesis method.

The first step S110 may include preparing a mixed solution by mixing a cerium precursor and a titanium precursor and forming metal oxide particles through a hydrothermal synthesis method in which the mixed solution is heated at a temperature of 50 to 100° C. for about 8 to 16 hours.

In the first step S110, metal nitride particles represented by the following Chemical Formula 1 may be formed via the hydrothermal synthesis method.

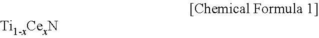

In the Chemical Formula 1, x is a real number greater than or equal to 0.025 and less than or equal to 0.075.

In an embodiment, in the Chemical Formula 1, x may be a real number greater than or equal to 0.025 and less than or equal to 0.050, or a real number greater than or equal to 0.050 and less than or equal to 0.075.

In the second step S120, the metal oxide particles may be converted into the metal nitride particles by heat-treating the metal oxide particles in a nitrogen-containing atmosphere.

In an embodiment, the metal nitride particles may be formed by heat-treating the metal oxide particles at a temperature of 600 to 1000° C. for 0.5 to 3 hours in an ammonia gas atmosphere, and the metal nitride particles formed by such heat treatment in the nitrogen-containing atmosphere may be crystalline with a rock salt structure.

In an embodiment, the metal nitride particles may be formed to have a size of 5 to 50 nm.

In the third step S130, the layered metal double hydroxide nanosheets may be grown on the surface of the metal nitride particles through a hydrothermal synthesis method.

In an embodiment, the layered metal double hydroxide nanosheets may be grown on the surface of the metal nitride particles through a hydrothermal synthesis method in which, while the metal nitride particles are dispersed in a mixed precursor solution for the layered metal double hydroxide nanosheets, the mixed precursor solution is heated to about 120 to 200° C. for about 20 to 48 hours in an inert atmosphere.

In an embodiment, the third step S130 may include preparing a reaction solution by adding a mixed precursor solution for the layered metal double hydroxide nanosheets to a mixed solution containing the metal nitride particles and stirring the reaction solution to form a reactant, and washing and drying the reactant to obtain a metal nitride hybrid composite catalyst. In this case, the reaction solution may be stirred to grow layered double hydroxide nanosheets on the surface of the metal nitride particles.

In an embodiment, when the layered metal double hydroxide nanosheet is formed of a material of the following Chemical Formula 2, the mixed precursor solution may be prepared by mixing a first solution in which the M¹ precursor material and the M² precursor material are dissolved with a second solution containing an interlayer anion together with an alkaline solution. In this case, the M¹ precursor material and the M² precursor material may each include an M¹ metal salt and an M² metal salt.

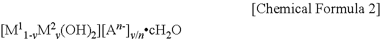

In the Chemical Formula 2, M¹ is a first transition metal cation having an oxidation state of +2, M² is a second transition metal cation having an oxidation state of +3, A is an interlayer anion having an oxidation state of −n, y is a real number satisfying the condition of “0<y<1”, n is an integer greater than or equal to 1 and less than or equal to 5, and c is a positive real number.

In the third step S130, the M¹ metal salt may include a first nitride containing the first transition metal cation described above, and the M² metal salt may include a second nitride containing the second transition metal cation described above. For example, when the layered metal double hydroxide catalyst includes Ni—Fe LDH, the first metal salt may include Ni(NO₃)₂6H₂O, and the second metal salt may include Fe(NO₃)₃6H₂O.

### <Water Electrolysis Apparatus>

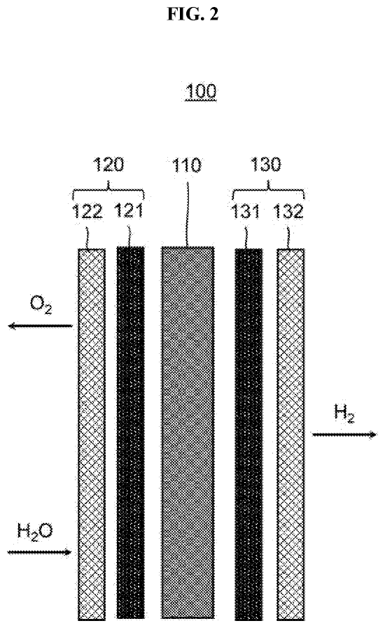

FIG. 2 shows a diagram to illustrate a water electrolysis apparatus according to an embodiment of the present disclosure.

Referring to FIG. 2, a water electrolysis apparatus 100 according to an embodiment of the present disclosure may include an ion exchange membrane 110, a first electrode 120, and a second electrode 130.

Any ion exchange membrane conventionally used in water electrolysis apparatuses may be applied to the ion exchange membrane 110 without limitation. For example, the ion exchange membrane 110 may include a cation exchange membrane or an anion exchange membrane.

The first electrode 120 and the second electrode 130 may be arranged to face each other with the ion exchange membrane 110 interposed therebetween.

An oxygen evolution reaction (OER) may take place at the first electrode 120, and a hydrogen evolution reaction (HER) may take place at the second electrode 130.

The first electrode 120 may include a first catalyst layer 121 disposed adjacent to the ion exchange membrane 110 and a first gas diffusion layer 122 disposed on an outer side of the first catalyst layer 121.

In an embodiment, the first catalyst layer 121 may include a metal nitride hybrid composite catalyst according to the embodiment of the present disclosure described above, and any gas diffusion layer conventionally used in water electrolysis apparatuses may be applied to the first gas diffusion layer 122 without limitation.

The second electrode layer 130 may include a second catalyst layer 131 positioned to face the first catalyst layer 121 with the ion exchange membrane 110 interposed therebetween, and a second gas diffusion layer 132 disposed on tan outer side of the second catalyst layer 131. As the second catalyst layer 131 and the second gas diffusion layer 132, a catalyst layer and a gas diffusion layer conventionally used for a hydrogen generation electrode of water electrolysis apparatuses may be applied without limitation.

### <Metal-Air Secondary Battery>

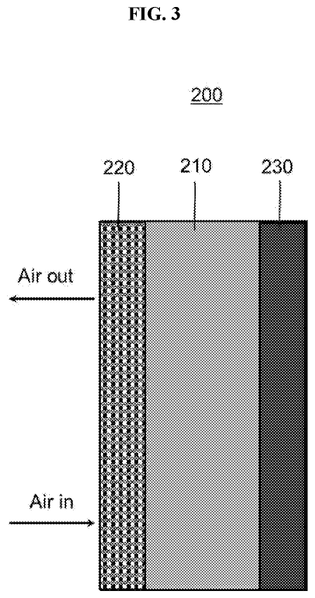

FIG. 3 shows a diagram to illustrate a metal-air secondary battery according to an embodiment of the present disclosure.

Referring to FIG. 3, a metal-air secondary battery 200 according to an embodiment of the present disclosure may include an air electrode 220, a metal electrode 230, and an electrolyte 210.

The air electrode 220 and the metal electrode 230 may be spaced apart from each other with the electrolyte 210 interposed therebetween.

The air electrode 220 may have a porous structure and may include a catalyst for oxygen reduction reaction (ORR). For example, the air electrode 220 may include a layered metal nitride hybrid composite catalyst according to the embodiment of the present disclosure as described above.

The metal electrode 230 may include a metal such as zinc (Zn), lithium (Li), or aluminum (Al).

During discharging of the metal-air secondary battery 200, hydroxide ions (OH⁻) may be generated at the air electrode 220 through an oxygen reduction reaction (ORR), and metal hydroxide and electrons may be generated at the metal electrode 230 through a reaction between the metal forming the metal electrode 230 and the hydroxide ions. In addition, during charging of the metal-air secondary battery 200, oxygen, water, and electrons may be generated from the hydroxide ions (OH⁻) at the air electrode 220, and metal, water, and hydroxide ions may be generated at the metal electrode 230 by the reaction of the metal hydroxide and electrons.

Hereinafter, specific embodiments of the present disclosure will be described in detail. However, the following examples are only some embodiments of the present disclosure, and the scope of the present disclosure is not limited to the following examples.

### Examples 1-1, 1-2, 1-3

Step 1: Synthesis of a Ce-Substituted Ti₁₋ₓCeₓO₂ Precursor

(NH₄)₂[Ce(NO₃)₆] was dispersed in 4 mL of ethanol, 1 mL of TiCl₄ solution was added dropwise with stirring, and then 20 mL of anhydrous benzyl alcohol was added and stirred for 10 minutes. The mixed solution was transferred to a hydrothermal synthesizer to carry out a reaction at 85° C. for 12 hours. After the hydrothermal synthesis, 80 mL of diethyl ether was added to the reaction solution to induce precipitation, and then the precipitate was filtered using a centrifuge (4000 rpm, 5 min). The precipitation was carried out with a reaction using a furnace at 400° C. for 2 hours to produce Ti₁₋ₓCeₓO₂. Specifically, Ti_{0.0975}Ce_{0.025}O₂ (Example 1-1), Ti_{0.095}Ce_{0.05}O₂(Example 1-2), and Ti_{0.0925}Ce_{0.075}O₂(Example 1-3) were prepared depending on the element ratios of the cerium-substituted metal nitride. Hereinafter, the metal oxides finally synthesized in Step 1 are named 7.5CTO, 5CTO, and 2.5CTO, respectively.

Step 2: Synthesis of Ce-Substituted Ti₁₋ₓCeₓN

Ti₁₋ₓCeₓN nanoparticles were synthesized by heat treating 7.5CTO, 5CTO, and 2.5CTO obtained in Step 1 at 900° C. for 1 hour in the presence of ammonia gas. The heating rate was set as follows: 5° C./min from 25 to 300° C., 2° C./min from 300 to 700° C., and 1° C./min from 700 to 900° C. In the following, the metal nitride nanoparticles finally synthesized in Step 2 are named 7.5CTN, 5CTN, and 2.5CTN, respectively.

Step 3: Synthesis of Ti₁₋ₓCeₓN/LDH Nanohybrid

A Ti₁₋ₓCeₓN/LDH nanosheet hybrid was synthesized using each of the 7.5CTN, 5CTN, and 2.5CTN nanoparticles synthesized in Step 2. 7.5 CTN, 5 CTN, and 2.5 CTN nanoparticles were each dispersed in 30 ml of water, and 0.3 mmol Ni(NO₃)₂·6H₂O, 0.1 mmol Fe(NO₃)₃·9H₂O, 0.75 mmol urea, and 0.05 mmol Na₂CO₃ were added and stirred for 15 minutes. The stirred solution was transferred to a hydrothermal synthesizer and reacted at 150° C. for 24 hours. After the reaction, the resulting product was washed with excess water and ethanol and dried in an oven at 60° C. for 12 hours. The hybrids synthesized in Step 3 were named 7.5CTNL, 5CTNL, and 2.5CTNL, respectively.

### Comparative Example 1-1

Commercially purchased titanium dioxide (hereinafter referred to as TO) was obtained.

### Comparative Example 1-2

Titanium nitride (hereinafter referred to as TiN) was prepared in the same manner as in Step 2 of the Example, except that commercially available titanium dioxide (Comparative Example 1-1) was used instead of metal oxide.

### Comparative Example 1-3

TiN-LDH (hereinafter referred to as TNL) was prepared in the same manner as in Step 3 of the Example, except that titanium nitride prepared in Comparative Example 1-2 was used instead of metal nitride nanoparticles.

The Ti₁₋ₓCeₓN/LDH nanohybrids prepared in the Examples and Comparative Examples are listed in Table 1 below.

TABLE 1

| Substance | Name | Substance | Name | Substance | Name |
|---|---|---|---|---|---|
| TiO₂ | TO | TiN | TN | TiN-LDH | TNL |
| Ce_{0.025}Ti_{0.975}O₂ | 2.5CTO | Ce_{0.025}Ti_{0.975}N | 2.5CTN | Ce_{0.025}Ti_{0.975}N-LDH | 2.5CTNL |
| Ce_{0.05}Ti_{0.95}O₂ | 5CTO | Ce_{0.05}Ti_{0.95}N | 5CTN | Ce_{0.05}Ti_{0.95}N-LDH | 5CTNL |
| Ce_{0.075}Ti_{0.925}O₂ | 7.5CTO | Ce_{0.075}Ti_{0.925}N | 7.5CTN | Ce_{0.075}Ti_{0.925}N-LDH | 7.5CTNL |

### Experimental Example

1.6 mg of the catalysts prepared in Examples 1-1 to 1-3 and Comparative Examples 1-1 to 1-3 and 0.4 mg of conductive carbon (Vulcan-XC72R) were added to 0.8 ml of tertiary distilled water and 0.2 ml of isopropanol solution, and 20 μl of 5 wt % Nafion solution was added and dispersed using ultrasonic waves for 1 hour. 10 μl of the dispersed solution was taken and sampled on glassy carbon (GC), and the catalytic performance was measured using IviumStat. A saturated calomel electrode (SCE) was used as the reference electrode, and a platinum wire (Pt wire) was used as the counter electrode. Measurement was performed to test catalytic activity for the oxygen evolution reaction using RRDE-3A Rotating Ring Disk Electrode Apparatus (Manufacturer: ALS). The measurement was performed in a 1 M KOH solution saturated with nitrogen gas at a scan rate of 5 mV/s.

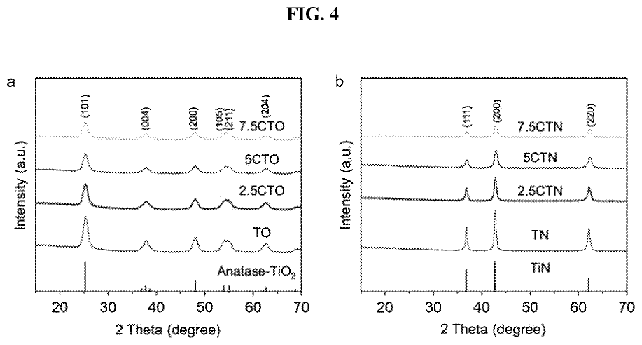

FIG. 4 shows an X-ray powder diffraction pattern of Ti₁₋ₓCeₓO₂ and Ti₁₋ₓCeₓN precursors synthesized with various substitution ratios.

Referring to FIG. 4a, it was confirmed that both Ti₁₋ₓCeₓO₂ having various Ce substitution ratios and unsubstituted TiO₂ exhibit an anatase TiO₂ crystal structure without impurities. When the lattice parameter was obtained, it was observed that the Ce with a lager size was successfully substituted into TiO₂ through the increase in lattice volume after Ce substitution. Referring to FIG. 4b, it was confirmed that both Ce-substituted Ti₁₋ₓCeₓN after ammonia heat treatment and unsubstituted TiN exhibit a typical TiN crystal structure.

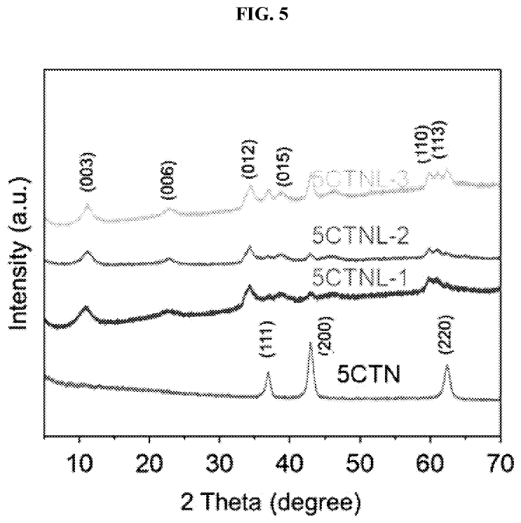

FIG. 5 shows an X-ray powder diffraction pattern of Ti₁₋ₓCeₓN-LDH nanohybrid (Example 1-2).

Referring to FIG. 5, the crystal structures of both TiN and LDH may be confirmed from XRD data, indicating that the Ti₁₋ₓCeₓN-LDH nanohybrid was synthesized well without impurities.

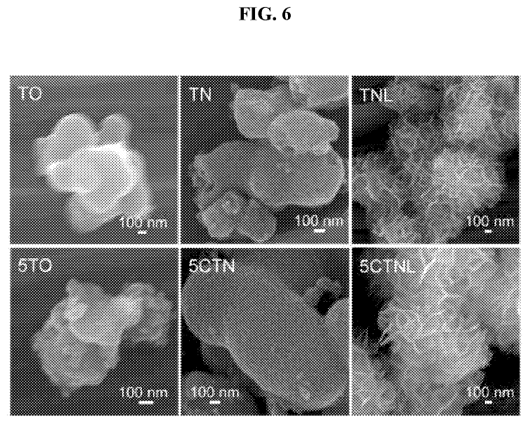

FIG. 6 shows field emission scanning electron microscopic (FE-SEM) images of a Ti₁₋ₓCeₓN-LDH nanohybrids (Example 1-2, Comparative Examples 1-1 to 1-3).

Referring to FIG. 6, it was confirmed that both the precursor TiO₂ and Ce-substituted TiO₂ had particle shapes, and that some pores were formed on the surface after ammonia heat treatment. Based on this, it was confirmed that both TiN-LDH (TNL) and Ti₁₋ₓCeₓN-LDH (5CTNL) nanohybrids exhibit a nanosheet morphology after growing LDH nanosheets on the surface.

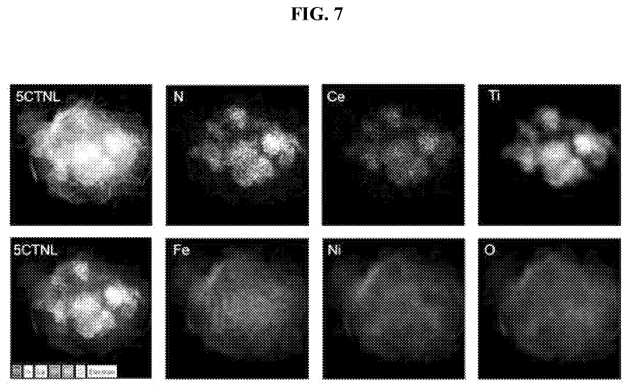

FIG. 7 is TEM elemental mapping images of the synthesized Ti₁₋ₓCeₓN-LDH nanohybrid (Example 1-2).

Referring to FIG. 7, it can be seen that N, Ce, Ti, Fe, Ni, and O are evenly distributed in the 5CTNL catalyst, and through the element distribution, it can be seen that there are Ti₁₋ₓCeₓN nanoparticles in the core with LDH grown on the outer side thereof.

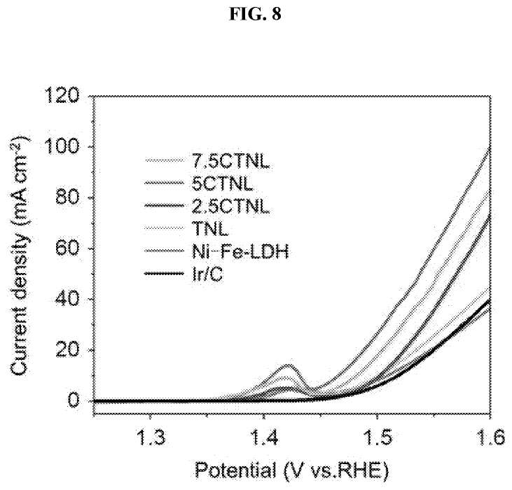

FIG. 8 shows result data of the oxygen evolution reaction (OER) catalytic activity of catalysts in Examples 1-1 to 1-3 and Comparative Examples 1-1 to 1-3.

Referring to FIG. 8, the synthesized catalysts were measured in a 1M KOH solution, and the scan rate was set to 5 mV/s. The measurement results showed that the Ce-substituted Ti1−xCexN-LDH (CTNL) nanohybrids had much better oxygen-generating catalytic activity than the unsubstituted TiN-LDH (TNL). Among them, 5CTNL showed the best performance, which was better than that of commercialized iridium catalyst materials.

Although the present disclosure has been described above with reference to preferred embodiments, it will be understood by those skilled in the art that various modifications and changes may be made to the present disclosure without departing from the spirit and scope of the present disclosure as set forth in the appended claims.

What is claimed is:

1. A metal nitride hybrid composite catalyst comprising:
a cerium-substituted metal nitride particle; and
a layered metal double hydroxide nanosheet grown on a surface of the metal nitride particle,
wherein the metal nitride hybrid composite catalyst exhibits catalytic activity for an oxygen evolution reaction (OER), a hydrogen evolution reaction (HER), or an oxygen reduction reaction (ORR).

2. The metal nitride hybrid composite catalyst of claim 1, wherein the layered metal double hydroxide nanosheet is arranged to form open pores on the surface of the metal nitride particle.

3. The metal nitride hybrid composite catalyst of claim 1, wherein the metal nitride particle is represented by the following Chemical Formula 1: 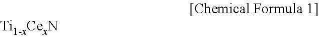
wherein, in the Chemical Formula 1, x is a real number greater than or equal to 0.025 and less than or equal to 0.075.

4. The metal nitride hybrid composite catalyst of claim 3, wherein the metal nitride particle is crystalline with a rock salt structure.

5. The metal nitride hybrid composite catalyst of claim 2, wherein the layered metal double hydroxide nanosheet comprises a material represented by the following Chemical Formula 2: 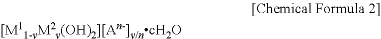
wherein, in the Chemical Formula 2, M¹ is a first transition metal cation having an oxidation state of +2, M² is a second transition metal cation having an oxidation state of +3, A is an interlayer anion having an oxidation state of −n, y is a real number satisfying the condition of “0<y<1”, n is an integer greater than or equal to 1 and less than or equal to 5, and c is a positive real number.

6. The metal nitride hybrid composite catalyst of claim 5, wherein the first transition metal cation comprises any one or more selected from the group consisting of Ca²⁺, Mg²⁺, Zn²⁺, Ni²⁺, Mn²⁺, Co²⁺, Fe²⁺, and Cu²⁺,
the second transition metal cation comprises one or more selected from the group consisting of Fe³⁺, Al³⁺, Cr³⁺, Mn³⁺, Ga³⁺, Co³⁺, V³⁺, Y³⁺, and Ni³⁺, and
the interlayer anion comprises one or more selected from the group consisting of OH⁻, Cl⁻, Br⁻, I⁻, NO₃⁻, CO₃²⁻, HCO₃⁻, SO₄²⁻, PO₄³⁻, HPO₄²⁻ and H₂PO₄⁻.

7. A method of manufacturing a metal nitride hybrid composite catalyst, the method comprising:
a first step of forming cerium-substituted metal oxide particles using a hydrothermal synthesis method;
a second step of converting the metal oxide particles into metal nitride particles; and
a third step of forming layered metal double hydroxide nanosheets on a surface of the metal nitride particles using a hydrothermal synthesis method.

8. The method of claim 7, wherein the second step is performed by heat treating the metal oxide particles in a nitrogen-containing atmosphere.

9. The method of claim 8, wherein the second step is performed by heat treating the metal oxide particles at a temperature of 600° C. to 1000° C. for 0.5 to 10 hours under an ammonia gas atmosphere.

10. The method of claim 7, wherein the third step is performed, while the metal nitride particles are dispersed in a mixed precursor solution for a layered metal double hydroxide, by heating the mixed precursor solution in an inert atmosphere to 120 to 200° C. for 20 to 48 hours, and
wherein, during the third step, the layered metal double hydroxide nanosheets are grown on the surface of the metal nitride particles.

11. The method of claim 10, wherein the metal nitride particles are formed to have a size of 5 to 50 nm.

12. A water electrolysis apparatus comprising: an ion exchange membrane; and a first electrode and a second electrode facing each other with the ion exchange membrane interposed therebetween,
wherein the first electrode, in which an oxygen evolution reaction (OER) occurs, comprises a metal nitride hybrid composite catalyst comprising: a cerium-substituted metal nitride particle; and a layered metal double hydroxide nanosheet formed on a surface of the metal nitride particle.

13. The water electrolysis apparatus of claim 12, wherein the first electrode comprises a first catalyst layer disposed adjacent to the ion exchange membrane and a first gas diffusion layer disposed on an outer side of the first catalyst layer, and
wherein the first catalyst layer comprises a layered metal double hydroxide catalyst.
